(19) United States
(12) Patent Application Publication
(10) Pub. No.: US 2012/0091878 A1
(43) Pub. Date: Apr. 19, 2012

(54) ELECTRON BEAM DISPLAY

(75) Inventor: Minoru Ookoba, Sagamihara-shi (JP)

(73) Assignee: CANON KABUSHIKI KAISHA, Tokyo (JP)

(21) Appl. No.: 13/248,373

(22) Filed: Sep. 29, 2011

(30) Foreign Application Priority Data
Oct. 18, 2010 (JP) 2010-233368

(51) Int. Cl. H01J 31/15

(52) U.S. Cl. 313/408

(57) ABSTRACT

In an electron beam display in which electron-emitting devices 10 each emit an electron beam 5 that is non-uniform on the electron beam 5 irradiation surface of a corresponding pixel 7, the present invention allows possible luminance unevenness to be prevented while maintaining the brightness of a screen. The electron beam display includes light transmission suppressing portions 12 configured to cover respective light-transmitting apertures 8 each formed in the corresponding pixel 7 in order to allow light to be derived through the aperture, corresponding to a position on the electron beam 5 irradiation surface where the pixel 7 irradiated with the electron beam 5 by the electron-emitting device 10 exhibits the highest current density; and to have 10% to 28% of the aperture 8 in area.

### BACKGROUND OF THE INVENTION

1. Field of the Invention

The present invention relates to an electron beam display, and in particular, to a configuration of a face plate with a light emitting portion.

2. Description of the Related Art

In the conventional art, Japanese Patent Application Laid-Open No. H05-188214 discloses a method for printing with color filters in which the distribution of thickness of the color filters distributed all over pixels is controlled by controlling the size of apertures in a printing plate and the number of printing operations.

Furthermore, Japanese Patent Application Laid-Open No. 2009-252440 discloses improvement of contrast based on an increase in the occupancy rate of a black matrix resulting from a shielding area provided inside each pixel.

The electron beam display poses the following problems. Electron beams emitted to the pixels normally have non-uniform current densities. Furthermore, luminance unevenness may result from the likelihood of deviation of the irradiation positions of the electron beams.

Distribution control for a color display as disclosed in Japanese Patent Application Laid-Open No. H05-188214 is effective for making the luminance within each pixel uniform in, for example, a liquid crystal display in which light emission is uniform within the pixel.

However, in the electron beam display, the electron beams emitted to the pixels normally have non-uniform current densities, and the deviation of irradiation positions of the electron beams may cause luminance unevenness. Thus, even if the technique disclosed in Japanese Patent Application Laid-Open No. H05-188214 is applied to control the distribution of thickness of phosphors distributed all over the pixels, the luminance unevenness of the electron beam display is insufficiently corrected.

According to Japanese Patent Application Laid-Open No. 2009-252440, a shielding area is provided which is at least 30%, in size, of an aperture through which light resulting from light emission from the phosphors is derived. This may disadvantageously reduce the brightness of a screen.

The present invention has been made in view of the above-described conventional problems. An object of the present invention is to correct the luminance unevenness in the electron beam display with the brightness of the screen maintained.

### SUMMARY OF THE INVENTION

In order to accomplish the object, the present invention provides an electron beam display comprising: a face plate including a plurality of pixels having a phosphor emitting light responsive to irradiation with an electron, and a light transmitting aperture arranged correspondingly to each of the pixels for extracting light emitted from the phosphor; and a rear plate including a plurality of electron-emitting devices each arranged correspondingly to each of the plurality of pixels so as to irradiate electrons to the corresponding pixel, and so that an irradiation current density on an electron beam irradiation surface has an intensity distribution within the corresponding pixel, wherein a light transmission suppressing portion covers a position of the aperture corresponding to a position at which the irradiation current density of the electron beam is maximum and has an area of 10-28% of an area of the aperture on the electron beam irradiation surface.

According to the present invention, the light transmission suppressing portion is provided in an area centered at the position in which the electron beam exhibits the highest current density and which most significantly affects a change in luminance when the electron beam irradiation position is shifted. This prevents possible significant luminance unevenness even if the irradiation position of the electron beam, which has a distributed current density, is more or less shifted. Furthermore, the light transmission suppressing portion according to the present invention is 10% to 28% of the aperture in area. This prevents the luminance of each pixel from being greatly reduced, allowing a bright screen to be maintained.

Further features of the present invention will become apparent from the following description of exemplary embodiments with reference to the attached drawings.

### BRIEF DESCRIPTION OF THE DRAWINGS

FIGS. 1A and 1B are partial schematic diagrams of an electron beam display according to the present invention.

FIGS. 2A and 2B are diagrams illustrating a typical distribution of light emission.

FIGS. 3A, 3B 3C and 3D are diagrams illustrating a variation in a light emission position.

FIG. 4 is a diagram illustrating the distribution of light emission.

FIGS. 5A and 5B are diagrams illustrating a light emission profile based on integration in a Y direction.

FIG. 6 is a schematic diagram of a light transmission suppressing portion with a certain width in both an X direction and the Y direction.

FIGS. 7A and 7B are schematic diagrams of the light transmission suppressing portion with a light transmittance.

FIG. 8 is a graph illustrating an example of an increased variation in the tolerance of the size of the light transmission suppressing portion observed when the light transmission suppressing portion has a light transmittance.

FIG. 9 is a graph illustrating a desirable range according to a third exemplary embodiment.

FIG. 10 is a graph illustrating a light transmittance according to Example 6.

FIGS. 11A and 11B are diagrams illustrating Example 6.

FIGS. 12A and 12B are diagrams illustrating a light transmission suppressing portion with a light transmittance distribution.

FIGS. 13A, 13B and 13C are diagrams illustrating an optimum form of the light transmission suppressing portion.

FIGS. 14A and 14B are diagrams illustrating the relationship between a light emission peak and the position of the light transmission suppressing portion and a variation in the position.

FIGS. 15A, 15B and 15C are diagrams illustrating a second exemplary embodiment of the light transmission suppressing portion.

FIGS. 16A, 16B and 16C are diagrams illustrating the third exemplary embodiment of the light transmission suppressing portion.

FIGS. 17A and 17B are diagrams illustrating a fourth exemplary embodiment of the light transmission suppressing portion.

### DESCRIPTION OF THE EMBODIMENTS

Preferred embodiments of the present invention will now be described in detail in accordance with the accompanying drawings.

Examples of an electron beam display according to the present invention include a field emission electron beam display (FED), a surface conduction electron emission display (SED), and a cathode ray tube display (CRT) which include a plurality of pixels each having an electron source. In particular, the present invention may be applied to the FED and SED because these displays allow electron beams to be easily emitted to desired positions (allow the electron beams to be converged at the desired positions). Examples of the electron emission source used for the FED include a Spindt type, an MIM type, a carbon nanotube type, and a ballistic electron surface-emitting device (BSD) type.

Exemplary embodiments of the present invention will be described taking, as an example, an electron beam display produced using a common electron source.

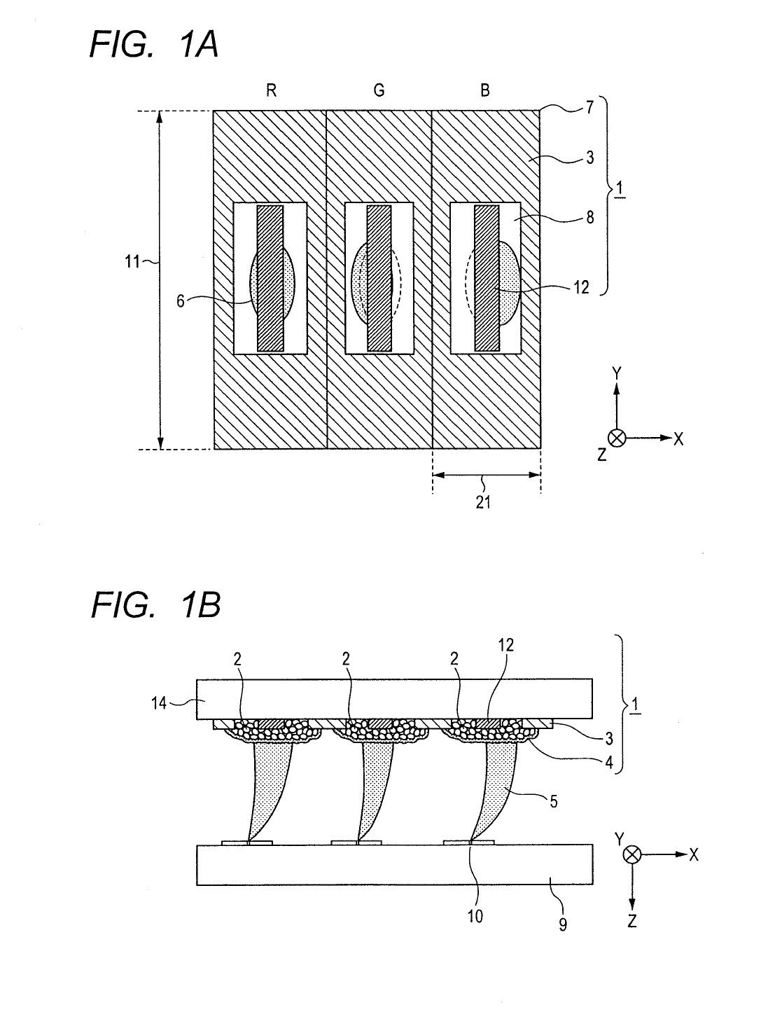

FIG. 1A is a schematic plan view illustrating that a face plate 1 of an electron beam display according to the present invention is emitting light. Furthermore, FIG. 1B illustrates a cross section of the face plate 1 of the electron beam display. FIG. 1B also illustrates orbits of electron beams 5. FIGS. 1A and 1B illustrate the face plate 1, phosphors 2, a black member 3, metal backs 4, the electron beams 5, main light emitting areas 6, pixels 7, apertures 8, a rear plate 9, electron-emitting devices 10, a Y-direction pixel pitch 11, light transmission suppressing portions 12, and a substrate 14.

In FIGS. 1A and 1B, XY coordinates are set in the plane of the face plate 1. For the XY coordinates, in the plane of the face plate 1, an X direction is defined as the direction of short sides (the direction in which colors are arranged so as to change sequentially) of the pixel 7, whereas a Y direction is defined as the direction of long sides (the direction in which the same color extends) of the pixel 7. Furthermore, a Z direction is defined as the direction of the gap (the direction in which the face plate 1 and the rear plate 9 lie opposite each other) between the face plate 1 and the rear plate 9 with the electron-emitting devices 10 arranged thereon.

The substrate 14 includes the phosphors 2 each emitting light when irradiated with the electron beam 5, the black member 3, and the metal backs 4. A transparent insulating substrate can be used as a material for the substrate 14 in order to allow light emission from the phosphors 2 to be observed based on transmission. Plate glass such as soda-lime glass can be used. Besides, high strain-point glass, used in the field of PDPs (Plasma Display Panels), can be used.

The phosphor 2 is a material that emits light when irradiated with the electron beam 5 to form an image. A plurality of the phosphors 2 is densely packed so as to cover the aperture 8. The aperture 8 is a light transmitting window portion formed in each pixel 7 in order to allow light resulting from light emission from the phosphors 2 to be derived through the aperture. Examples of the phosphor 2 may include a P22 phosphor 2, used for CRTs, and any other powdery phosphor 2 that emits light when excited by the electron beam. Alternatively, a thin film phosphor 2 may be used which is a similar material but which is produced by direct deposition on the substrate 14. Furthermore, the phosphor 2 is formed by one of a screen printing method, a photolithography method, an ink jet method, and a vapor deposition technique.

The black member 3 is also referred to as a black matrix or a black stripe. The black member 3 is used in order to prevent light emission colors from being mixed, to absorb outside light, and to increase the contrast of a bright place. The black member 3 includes a plurality of the apertures 8 formed therein. The black member 3 may be formed of one of a carbon black, a black pigment, a paste containing low melting-point glass frits, and a thin film containing Co or Mn. Furthermore, the black material 3 is formed by one of the screen printing method, the sputtering method, and the photolithography methods.

To prevent color mixture, the occupancy rate of the black member 3, that is, the numerical aperture, needs to be reduced. However, a simple reduction in numerical aperture may wane the beam to vary the luminance among the pixels 7 because the light emitting position may vary as a result of a variation in the position of the beam among the pixels 7.

The metal backs 4 are provided in order to apply an acceleration voltage required to accelerate electrons from the rear plate 9. The metal backs 4 are provided further to reflect a fraction of light emitted by the phosphors 2 which travels toward the rear plate 9, toward the substrate 14. Thin film-like metal may be used as the metal backs 4 because of the need to increase light reflectance while minimizing the loss of energy of the accelerated electron beam 5. Aluminum is particularly preferably used as the metal backs 4. Furthermore, the metal backs 4 are formed by one of a filming method known in the field of CRTs and a transfer method.

The light transmission suppressing portion 12 according to the present invention is used in order to reduce a variation in luminance between any pixels 7. The light transmission suppressing portion 12 is formed in the aperture. Like the black member 3, the light transmission suppressing portion 12 may be formed of one of a carbon black, a black pigment, a paste containing low melting-point glass frits, and a thin film containing Co or Mn. Furthermore, the light transmission suppressing portion 12 is formed by one of the screen printing method, the sputtering method, the photolithography methods, and the ink jet method. The light transmission suppressing portion 12 may be produced during the same process as that in which the black member 3 is produced. In particular, if the light transmission suppressing portion 12 is set to be an area with no light transmittance, the thickness and composition of the light transmission suppressing portion 12 are set so as to exhibit a light transmittance of at most about 5% for the corresponding light.

The electron-emitting devices (electron sources) 10 are provided on the rear plate 9, located opposite to the face plate 1.

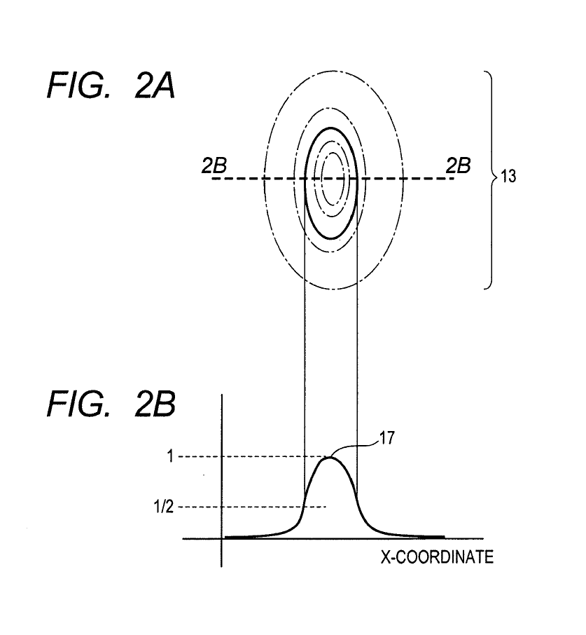

Now, a light emitting profile 13 will be described with reference to FIGS. 2A and 2B.

The electron beam 5 emitted by the electron-emitting device 10 and having a nonuniform current density fly from the rear plate 9 as illustrated in FIG. 1B and impinges on the phosphors 2 on the face plate 1. Then, as illustrated in FIG. 2A, a light emission distribution is generated which corresponds to the current density distribution of the electron beam 5. The light emission distribution is referred to as the light emission profile 13. In the electron beam display, the current density distribution of the electron beam 5 is generally shaped like a Gaussian distribution. As illustrated in FIG. 2B, a position in the light emission profile 13 which exhibits the largest light emission is referred to as a light emission peak 17. Furthermore, the main light emitting area 6 refers to an area enclosed by a contour corresponding to the half of the intensity indicated by the light emission profile 13 when the intensity of the light emission peak 17 of the light emission profile is normalized to 1. In general, as illustrated in FIGS. 2A and 2B, the light emission profile 13 includes a skirt located outside the main light emitting area 6 and exhibiting a gradual variation in intensity.

As described below, determination of the light emission profile 13 allows the optimum light transmission suppressing portions 12 to be correspondingly determined. Thus, the shape of the light emission profile 13 needs to be acquired. In general, the light emission profile 13 can be acquired by measurement with a CCD camera or the like from the substrate 14 side. However, the light emission profile 13 may be difficult to observe from the substrate 14 side. In such a case, the light emission profile 13 may be acquired using techniques described below.

Technique (1)

The light emission profile 13 is measured using the face plate 1 with large apertures 8 or with no black member 3 or light transmission suppressing portion 12. In specific measurements, both a two-dimensional luminance meter and a macro lens are used to pick up images of the light emission profile 13, which is moved on the XY stage. Image pickup pitch needs to correspond to a resolution with which the shape of the light emission profile 13 can be generally determined; the resolution is achieved when the image pickup pitch is equal to or smaller than about one-fifth of the size of the main light emitting area 6. Luminance values based on the image pickup correspond to the quantity of light emission from each dot. The light emission profile 13 can be determined by varying an acceleration voltage.

Technique (2)

A predicted profile of the electron beam 5 is derived based on the shape of the electron-emitting device 10, the shape of the rear plate 9, and the acceleration voltage, using electric field calculations and electron orbit calculations. Then, the light emission profile 13 is calculated with phosphor saturation characteristics taken into account. Then, a variation in the position of the electron beam 5 is estimated based on variations in the shapes of the electron-emitting device 10 and the rear plate 9. Thus, a variation in the position of the light emission profile 13 is calculated.

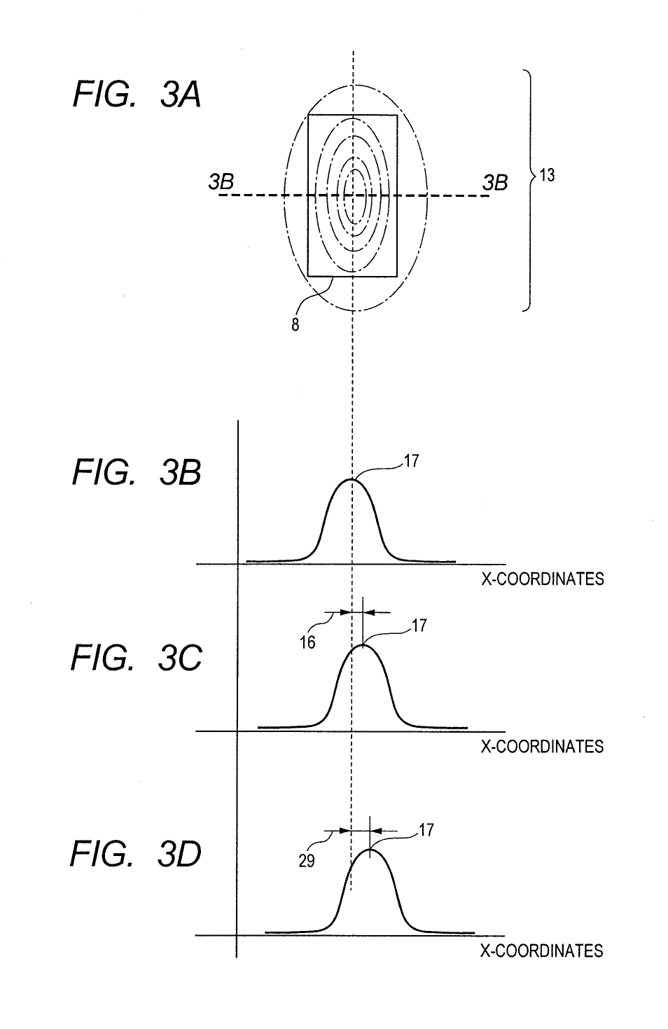

The position of the light emission profile 13 resulting from the electron beam 5 varies to some extent under the effect of a variation in the process of producing the electron-emitting devices 10 and a variation in expansion and contraction of the face plate 1 or the rear plate 9 during the process. The variation in a light emission position will be described with reference to FIGS. 3A to 3D. FIG. 3A is a diagram illustrating the positional relationship between the light emission profile 13 and the aperture 8 observed when the light emission peak 17 lies at the ideal position. FIG. 3B is cross-sectional view of the light emission profile 13 in FIG. 3A. FIG. 3C is a cross-sectional view of the light emission profile 13 obtained at another pixel 7 when the light emission peak 17 is shifted from the ideal position by a distance corresponding to a light emission position variation 16. FIG. 3D is a cross-sectional view of the light emission profile 13 obtained when the light emission position is most significantly shifted. All of FIGS. 3A to 3D are described taking the X direction as an example. The light emission position variation 16 is determined based on the light emission peak 17. A maximum variation 29 in a light emission position corresponds to the light emission position variation 16 obtained when the light emission position is most significantly shifted as illustrated in FIG. 3D. Furthermore, the standard deviation of the variation in light emission position may be determined so that the maximum variation 29 in light emission position can be set equal to one of 2σ and 3σ.

The position of the light emission peak 17 is generally designed so as to coincide with the center of the aperture 8 in order to maximize the light emission intensity. However, if the light emission profile 13 is not laterally symmetric, the optimum position may be shifted from the center of the aperture 8 in the XY direction by a given distance. In order to prevent possible color mixture, the quantity of the light emission position variation 16 is desirably set to be sufficiently small compared to the Y-direction pixel pitch 11 and a X-direction pixel pitch 21 (see FIGS. 1A and 1B) so that the above-described main light emission area 6 lies inside the aperture 8. As a rough indication, the quantity of the maximum variation 29 in light emission position is desirably equal to or smaller than 30% of the size of the main light emission area 6. The light emission position variation 16 causes the quantity of light blocked at the skirts of the light emission profile 13 to vary among the pixels 7. This leads to a variation in luminance among the pixels 7, that is, a luminance variation. It is generally known that the tolerable limit of the luminance variation corresponds to a luminance difference of about 2% and that the detectable limit of the luminance variation corresponds to a luminance difference of about 1%. The present invention presents a method of reducing the luminance variation resulting from the light emission position variation 16, down to at most the tolerable limit.

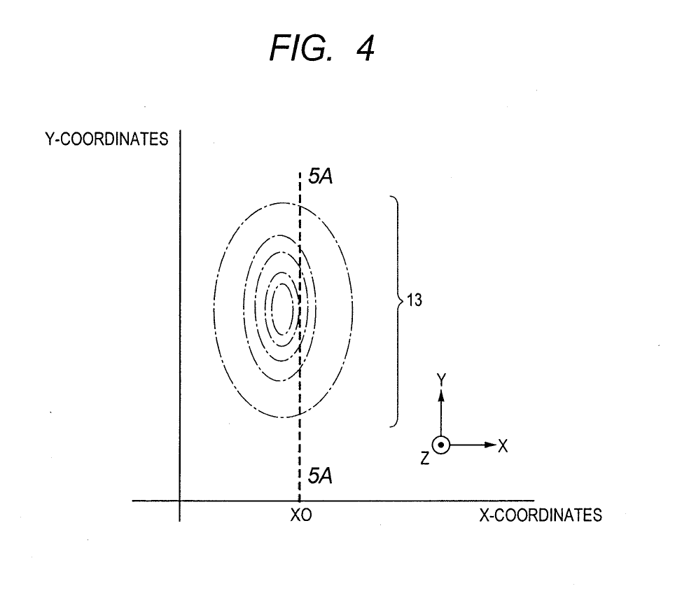

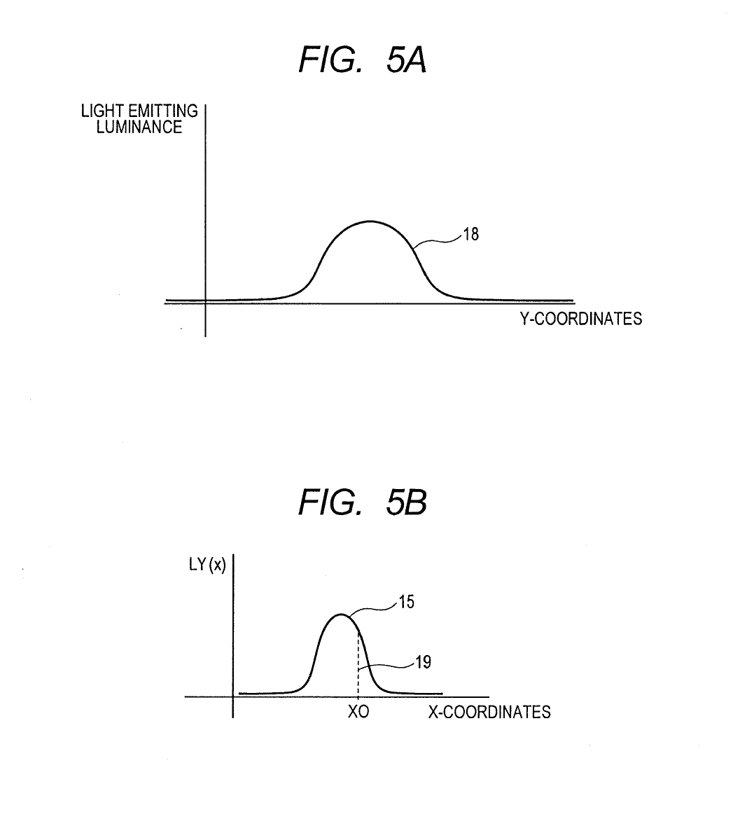

An integrated light emission profile 15 will be described with reference to FIG. 4 and FIGS. 5A and 5B. First, for the light emission profile 13 obtained without the aperture 8 or light transmission suppressing portion 12 as illustrated in FIG. 4, the changing curve of the light emission profile 13 along a line denoted by X=x is extracted (FIG. 5A). Integrating the changing curve allows an integral value 19 for a Y-direction cross section of the light emission profile 13 to be determined for each X coordinate (FIG. 5B). The light emission profile 15 thus results from the integration in the Y direction. In the description below, a function for the X coordinate is used to denote the light emission profile 15 resulting from the integration in the Y direction, as LY(x). Furthermore, LY′(x) denotes the inclination of X=x. That is, LY′(x) indicates the value of LY(x) differentiated with respect to x. Additionally, LY″(x) denotes the radius of curvature. That is, LY″(x) indicates the value for LY′(x) differentiated with respect to x.

As described above, the position of the light emission profile 13 resulting from the electron beam 5 varies to some extent under the effect of a variation in the process of producing the electron-emitting devices 10 and a variation in expansion and contraction of the face plate 1 or the rear plate 9 during the process. For example, if the face plate 1 and the rear plate 9 have the same heat history, when the plates are designed such that a position in the central pixel 7 where the electron beam exhibits the highest current density is located at the center of the pixel 7, a position in each of the peripheral pixels 7 where the electron beam exhibits the highest current density can also be easily located at the center of the pixel 7. However, when the heat history of the face plate 1 is greater than that of the rear plate 9, if both are the same in magnitude, the face plate 1 may be smaller than the rear plate 9. Thus, even when plates are designed such that the position in the central pixel 7 where the electron beam 5 exhibits the highest current density is located at the center of the pixel 7, the position in each of the peripheral pixels 7 where the electron beam 5 exhibits the highest current density may be biased toward an end of the pixel 7.

With the above-described heat histories, if the alignment is carried out in a central portion of the panel, the magnitude of the above-described positional deviation increases from the central portion to the peripheral portion of the panel. That is, the deviation does not occur randomly but normally often exhibits certain characteristics for each given area, which depends on causes of the deviation. Thus, the light transmission suppressing portions 12 according to the present invention can be formed as follows. That is, the electron-emitting devices 10 are divided into a plurality of groups corresponding to installation positions on the rear plate 9. Then, for each group to which the electron-emitting devices belong, a position on the electron beam irradiation surface where the electron beam exhibits the highest current density when the corresponding pixel is irradiated with the electron beam may be determined.

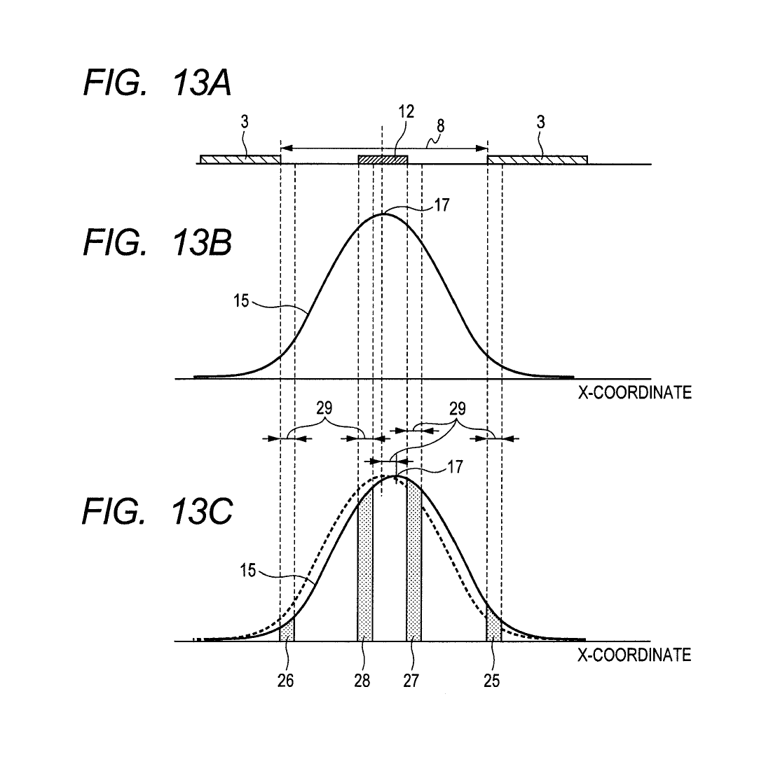

Now, a first exemplary embodiment of the light transmission suppressing portion 12 will be described with reference to FIGS. 13A to 13C. Components in FIGS. 13A to 13C denoted by the same reference numerals as those in FIG. 1, FIG. 4, and FIGS. 5A and 5B will not be described. Light emission 25 belongs to the integrated light emission profile 15 and exits the aperture 8 as a result of the maximum variation 29 in the light emission position in the X direction. Light emission 26 enters the aperture 8. Light emission 27 exits the light transmission suppressing portion 12 as a result of the maximum variation 29 in the light emission position in the X direction. Light emission 28 enters the light transmission suppressing portion 12. FIG. 13A is a cross-sectional view of the light transmission suppressing portion 12 and the black members 3 in the face plate 1. FIG. 13B is a diagram illustrating that the light emission peak 17 of the light emission profile 15 resulting from the integration in the Y direction lies at the center of the aperture 8. FIG. 13C is a diagram illustrating that the light emission profile 15 resulting from the integration in the Y direction is shifted rightward by a distance corresponding to the maximum variation 29 in the light emission position in the X direction.

First, it is assumed that the display includes no light transmission suppressing portion 12. When the integrated light emission profile 15 is subjected to an deviation rightward corresponding to the maximum variation 29 in the light emission position in the X direction, the light emission peak 17 is also shifted rightward as illustrated in FIG. 13C. This results in the light emission 25 exiting the aperture 8 and the light emission 26 entering the aperture 8. This difference corresponds to the quantity of change within the aperture 8. If the light emission profile 13 is shifted from the position corresponding to the maximum light emission quantity, the quantity of change in light emission constantly decreases.

In contrast, the presence of the light transmission suppressing portion 12 results in the light emission 27 exiting the light transmission suppressing portion 12 and the light emission 28 entering the light transmission suppressing portion 12. This difference constantly increases the quantity of change in light emission within the aperture 8 if the light emission profile 13 is shifted from the position corresponding to the maximum quantity of light emission. That is, the luminance variation can be suppressed by allowing the quantity of light emission blocked by the aperture 8 and the quantity of light emission blocked by the light transmission suppressing portion 12 to be deviation with each other.

The light transmission suppressing portion 12 needs to be 10% to 28% of the aperture 8 in area. If the light transmission suppressing portion 12 is less than 10% of the aperture 8 in area, the luminance variation is insufficiently suppressed. If the light transmission suppressing portion 12 is more than 28% of the aperture 8 in area, the screen gets darker.

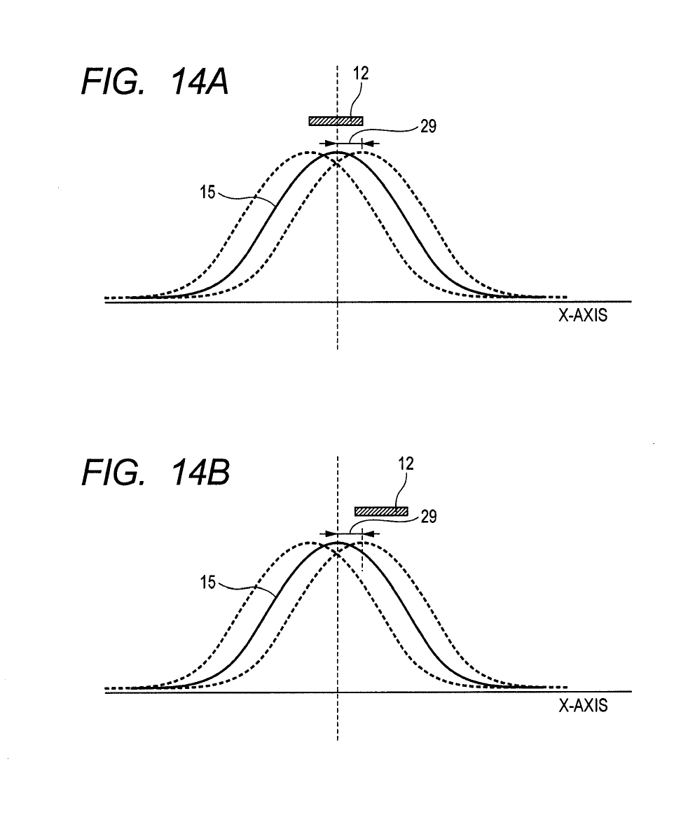

Furthermore, the position of the light transmission suppressing portion 12 can meet the following relationship. First, the light transmission suppressing portion 12 needs to cover the average position of the light emission peak 17 for all the pixels 7. FIGS. 14A and 14B are a schematic diagram of the relationship between the light emission peak 17 and the position of the light transmission suppressing portion 12. FIG. 14A illustrates that the light transmission suppressing portion 12 covers the light emission peak 17. FIG. 14B illustrates that the light transmission suppressing portion 12 does not cover the light emission peak 17. Components in FIG. 14A and FIG. 14B which are denoted by the same reference numerals as those in FIG. 4 and FIGS. 5A and 5B will not be described. If the light transmission suppressing portion 12 covers the light emission peak 17, the total quantity of light emission exiting the light transmission suppressing portion 12 and entering the aperture 8 increases when the integrated light emission profile 15 is shifted by the light emission position variation 16, regardless of the direction of the shift. That is, a decrease in the quantity of light emission resulting from blockage of the light emission by the aperture 8 can be deviation by the increase in the total light emission quantity.

However, if the light transmission suppressing portion 12 does not cover the light emission peak 17, when the light emission profile is shifted toward a minus side in the X axis direction by the distance corresponding to the light emission position variation 16, the quantity of light emission blocked by the light transmission suppressing portion 12 decreases. That is, the decrease in light emission quantity as a result of blockage of the light emission by the aperture 8 cannot be deviation. The light emission peak 17 is always covered with the light transmission suppressing portion 12 even when shifted by up to the distance corresponding to the maximum variation 29 in the light emission position.

For a similar reason, the aperture 8 needs to be larger, in size, than the maximum variation 29 in the light emission position, and one light transmission suppressing portion 12 needs to correspond to one light emission peak 17. If these conditions fail to be met, the luminance changes rapidly, thus increasing the luminance variation. The size of the light transmission suppressing portion 12 can be set equal to about 120 to 200% of the quantity of the light emission position variation 16 in order to allow a great quantity of light emission within the pixel to be obtained. Here, the light emission within the pixel is the total quantity of light emission through the aperture 8 except for a portion shielded by the light transmission suppressing portion 12.

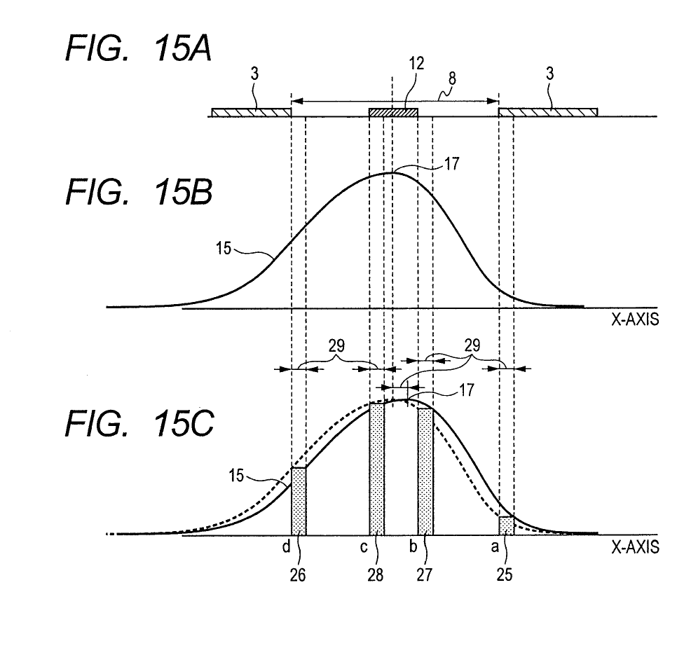

Now, a second exemplary embodiment will be described. The second exemplary embodiment corresponds to the first exemplary embodiment with the light transmission suppressing portion 12 specified in further detail. In the present exemplary embodiment, the light transmission suppressing portion 12 has no light transmittance. The term “no light transmittance” as used herein refers to a light transmittance of at most 5% as described above. FIGS. 15A to 15C is a diagram illustrating the second exemplary embodiment of the light transmission suppressing portion 12. FIG. 15A is a cross-sectional view of the black members 3 and the light transmission suppressing portion 12 in the X direction. FIG. 15B is a diagram illustrating the light emission profile 15 resulting from the integration in the Y direction. FIG. 15C is a diagram illustrating that the light emission profile 15 resulting from the integration in the Y direction is shifted by the distance corresponding to the maximum variation 29 in the light emission position. Reference numerals in FIGS. 15A to 15C are similar to those in FIGS. 13A to 13C and will not be described.

Expressions for a variation in light emission quantity are illustrated below. Expression (1-a) indicates the light emission 25, and Expression (1-b) indicates the light emission 26. Expression (1-c) indicates the light emission 27, and Expression (1-d) indicates the light emission 28. Expression (1-e) indicates the sum of these light emissions. The X coordinate of both ends of the aperture 8 are denoted by (a) and (d). The X coordinates of both ends of the light transmission suppressing portion 12 are denoted by (c) and (d). It is assumed that d<c<b<a. Furthermore, Δx denotes the maximum variation in the X direction in the light emission profile in all the pixels. The light emission quantity within the pixel refers to the total quantity of light emission through the pixel except for the portion shielded by the light transmission suppressing portion. Here, the end of the aperture 8 refers to the end of the aperture 8 in the black member 3, which is located at a position corresponding to 50% of the maximum light transmittance in the aperture 8. Furthermore, the end of the light transmission suppressing portion 12 refers to the end of the light transmission suppressing portion 12, which is located at a position corresponding to a light transmittance of 0.8×T1+0.2×T2 where T1 denotes the maximum light transmittance within the aperture 8 and where T2 denotes the minimum light transmittance of the light transmission suppressing portion.

Expression 1

(−)LY(a)·Δx (1-a)

(+)LY(d)·Δx (1-b)

(−)LY(b)·Δx (1-c)

(+)LY(c)·Δx (1-d)

{LY(d)−LY(a)+LY(b)−LY(c)}·Δx (1-e)

If the display includes no light transmission suppressing portion 12, a change in light emission expressed by {LY(d)−LY(a)}Δx occurs. This value cannot be set to zero as described in the first exemplary embodiment. However, provision of the light transmission suppressing portion 12 allows {LY(b)−LY(c)}Δx to cause a light emission change with a sign reverse to that of {LY(d)−LY(a)}Δx. That is, LY(a)+LY(c) and LY(b)+LY(d) can be made nearly equal. The term “nearly equal” as used herein means that the two values are desirably generally close to the tolerable limit. Namely, the absolute value of the difference between LY(a)+LY(c) and LY(b)+LY(d) may be equal to or smaller than 0.02 times a value obtained by dividing the light emission quantity within the pixel by Δx. Furthermore, the above-described 0th order approximation is applicable only if the maximum variation 29 Δx in the light emission position is sufficiently small compared to the quantity of change in the integrated light emission profile 15 and is approximately equal to or smaller than 20% of half-value width of the integrated light emission profile 15.

If the above-described relationship is established not only in the X direction but also in the Y direction, the luminance variation can be reduced not only in the X direction but also in the Y direction. That is, it is assumed that the light transmission suppressing portion 12 has a light transmittance of at most 5%. For the light emission profile 13 obtained without the light transmission suppressing portion 12, any Y coordinate value is denoted by y. The integral value of changing curve of the light emission profile 13 along a line denoted by Y=y is expressed by the function LX(y) of the Y coordinate. The Y coordinates of opposite ends of the aperture 8 are denoted by (e) and (h). The Y coordinates of both ends of the light transmission suppressing portion 12 are denoted by (f) and (g). Furthermore, Δy denotes the maximum variation in the light emission profile 13 in all the pixels, in the Y direction. Then, when h<g<f<e, the absolute value of the difference between LX(e)+LX(f) and LX(g)+LX(h) may be equal to or smaller than 0.02 times a value obtained by dividing the light emission quantity within pixel by Δy.

If the light emission profile 13 is appropriately laterally symmetric with respect to the light emission peak 17, the following relationship is established. The relationship will be described using expressions illustrated below. Expression 2 quantitatively indicates the varying light emission quantity illustrated in FIGS. 13A to 13C. The X coordinates of the ends of the aperture 8 are denoted as ±a. The X coordinates of the ends of the light transmission suppressing portion 12 are denoted as ±b.

$$\begin{matrix} Expression 2 & \\ Light Emission Entering Aperture = \frac{LY ( a ) + LY ( a ) - Δ x \cdot {LY}^{′} ( - a )}{2} \cdot Δ x & ( 2 \text{-} a ) \\ = LY ( a ) \cdot Δ x + \frac{1}{2} \cdot {LY}^{′} ( a ) \cdot {( Δ x )}^{2} & ( 2 \text{-} b ) \\ \begin{matrix} ( + ) & LY ( a ) \cdot Δ x + \frac{1}{2} \cdot {LY}^{′} ( a ) \cdot {( Δ x )}^{2}\end{matrix} & ( 2 \text{-} c ) \\ \begin{matrix} ( - ) & LY ( a ) \cdot Δ x - \frac{1}{2} \cdot {LY}^{′} ( a ) \cdot {( Δ x )}^{2}\end{matrix} & ( 2 \text{-} d ) \\ \begin{matrix} ( + ) & LY ( b ) \cdot Δ x - \frac{1}{2} \cdot {LY}^{′} ( b ) \cdot {( Δ x )}^{2}\end{matrix} & ( 2 \text{-} e ) \\ \begin{matrix} ( - ) & LY ( b ) \cdot Δ x + \frac{1}{2} \cdot {LY}^{′} ( b ) \cdot {( Δ x )}^{2}\end{matrix} & ( 2 \text{-} f ) \\ Quantity of Light Emission Variation ( total ) = \{ {LY}^{′} ( b ) - {LY}^{′} ( a ) \} \cdot {( Δ x )}^{2} & ( 2 \text{-} g ) \\ \vert \{ {LY}^{′} ( b ) - {LY}^{′} ( a ) \} \cdot {( Δ x )}^{2} \vert < 0.02 \times Light Emission within Pixel & ( 2 \text{-} h ) \\ \vert \{ {LY}^{′} ( b ) - {LY}^{′} ( a ) \} \vert < \frac{0.02 \times Light Emission within Pixel}{{( Δ x )}^{2}} & ( 2 \text{-} i )\end{matrix}$$

The light emission 26 entering the aperture 8 in the X direction can be expressed as Expression (2-a) based on the calculation of area of a trapezoid corresponding to a first-order approximation. Transforming Expression (2-a) on the assumption that LY(−x)=−LY(x) results in Expressions (2-b) and (2-c). Similarly, Expression (2-d) indicates the light emission 25 exiting the aperture 8. Expression (2-e) indicates the light emission 27 exiting the light transmission suppressing portion 12. Expression (2-f) indicates the light emission 28 entering the light transmission suppressing portion 12. The total quantity of these light emissions corresponds to the change quantity. Thus, the quantity of change in light emission (total quantity) resulting from a rightward shift by Δx can be expressed as Expression (2-g). Then, the quantity of change in light emission is made equal to or smaller than the tolerable limit of the luminance variation, that is, equal to or smaller than 2% of the light emission within the pixel, as indicated by Expression (2-h). Expression (2-h) can be further transformed into Expression (2-i).

As is apparent from Expression (2-i), the optimum arrangement of the light transmission suppressing portion 12 may be such that the light emission profile 15 based on the integration of light emissions at the ends of the black member 3 has almost the same inclination as that of the light emission profile 15 based on the integration of light emissions at the ends of the light transmission suppressing portion 12.

That is, when the X coordinates of both ends of the aperture 8 are denoted as ±a and the X coordinates of both ends of the light transmission suppressing portion 12 are denoted as ±b, then −a<−b<b<a is established. The inclinations of the function LY(x) at x=a and x=b are denoted by LY′(a) and LY′(b), respectively. The maximum variation in the light emission profile 13 in the X direction in all the pixels is denoted as Δx. The light emission quantity within the pixel refers to the total quantity of light emission through the aperture 8 except for the portion shielded by the light transmission suppressing portion 12. In this case, |LY′(b)−LY′(a)|<(0.02×light emission quantity within pixel)/(Δx)² may be satisfied.

If the above-described relationship is established not only in the X direction but also in the Y direction, the luminance variation can be reduced not only in the X direction but also in the Y direction. That is, when the integral value of the changing curve of the light emission profile 13 along a line denoted by Y=y is expressed by the function LX(y) of the Y coordinate, the Y coordinates of both ends of the aperture 8 are denoted as ±e, and the Y coordinates of both ends of the light transmission suppressing portion 12 are denoted as ±f, then −e<−f<f<e holds true. Then, the inclinations of the function LX(y) at y=e and y=f are denoted by LX′(e) and LX′(f), respectively. The maximum variation in the light emission profile 13 in the Y direction in all the pixels is denoted as Δy. The light emission quantity within the pixel refers to the total quantity of light emission through the aperture 8 except for the portion shielded by the light transmission suppressing portion 12. In this case, |LX′(f)−LY′(e)|<(0.02×light emission quantity within pixel)/(Δy)² may be satisfied.

The light emission quantity within the pixel 7 is approximately estimated from the emission profile 13 by integrating LY(x) within the range from the coordinate (a) of the end of the aperture 8 to the coordinate (b) of the end of the light transmission suppressing portion 12 and doubling the resultant integral value in view of the laterally located equivalent areas. Furthermore, a first-order approximation can be carried out according to Expressions (3-a) and (3-b) illustrated below. The term “appropriate symmetry” as used herein refers to a case where |LY(−x)−LY(x)|/LY(x) is equal to or smaller than 10% for any x.

$$\begin{matrix}Expression 3 & \\ \frac{LY ( b ) + LY ( a )}{2} \times ( b - a ) \times 2 & ( 3 \text{-} a ) \\ \{ LY ( b ) + LY ( a ) \} \times ( b - a ) & ( 3 \text{-} b )\end{matrix}$$

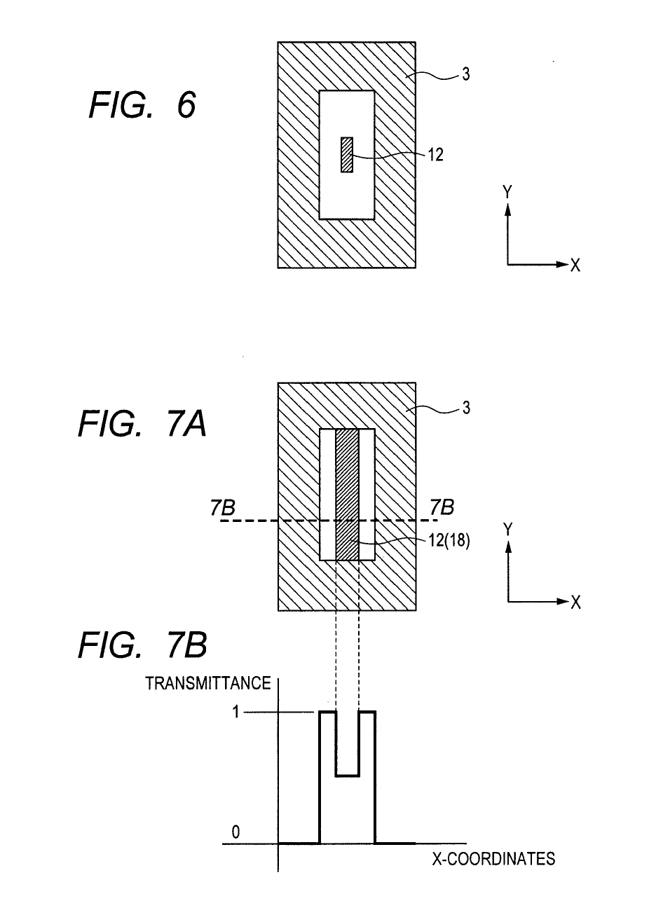

Each light transmission suppressing portion 12 may be present in both X and Y directions. An example is illustrated in FIG. 6.

Now, a third exemplary embodiment will be described.

The third exemplary embodiment is different from the second exemplary embodiment in that the light transmission suppressing portion 12 has a light transmittance. FIGS. 7A and 7B are a schematic diagram of the third exemplary embodiment. FIG. 7A is a diagram illustrating a light transmission suppressing portion 18 of a pixel 7 as seen from the Z direction. The illustrated light transmission suppressing portion 18 has a light transmittance T. FIG. 7B illustrates the light transmittance observed between d and d′. In the present exemplary embodiment, the light transmission suppressing portion 18 has an almost constant light transmittance. The term “almost constant transmittance” as used herein means that the light transmittance of the light transmission suppressing portion 18 varies within the range of ±5% of a certain value. The third exemplary embodiment is advantageous in that the almost constant light transmittance serves to provide a higher luminance (light emission within a pixel) than the case of no light transmittance corresponding to the second exemplary embodiment.

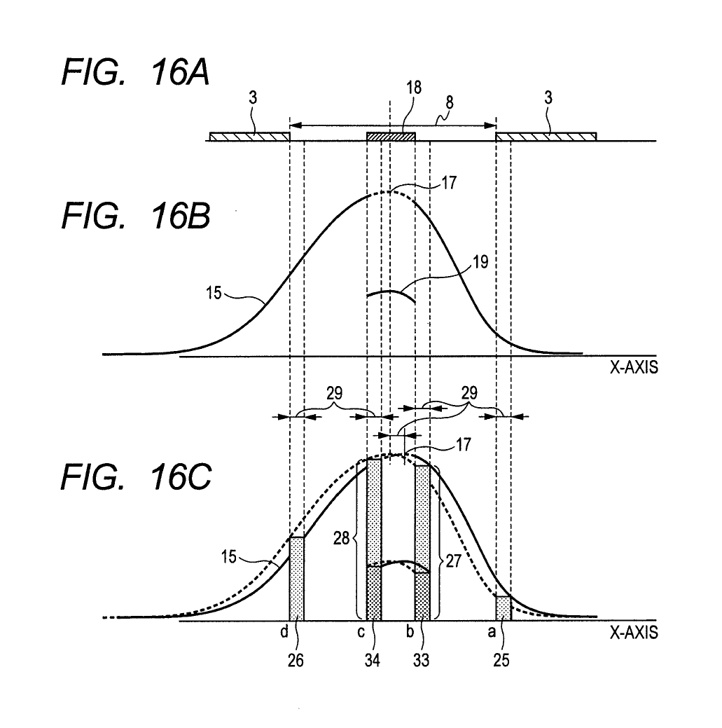

The relationship between the light emission profile 13 and the light transmission suppressing portion 18 will be described below. This will be described with reference to FIGS. 16A to 16C and Expression 4. Components in FIGS. 16A to 16C denoted by the same reference numerals as those in FIGS. 15A to 15C will not be described. In FIGS. 16A to 16C, a light emission 19 corresponds to the inside of the light transmission suppressing portion. A component 33 of the light emission exiting the light transmission suppressing portion 18 is attenuated. A component 34 of the light emission exiting the light transmission suppressing portion 18 is amplified. If the light transmission suppressing portion 18 has the light transmittance T, then as a result of the maximum variation 29 in the light emission position in the X direction, a light emission 27 exiting the light transmission suppressing portion 18 and entering the aperture 8 contributes to the light emission by a quantity corresponding to the light transmittance T before exiting the light transmission suppressing portion 18. Thus, the component 33 of the light emission exiting the light transmission suppressing portion 18 is attenuated. Furthermore, as a result of the maximum variation 29 in the light emission position in the X direction, a light emission 28 exiting the aperture 8 and entering the light transmission suppressing portion 18 is multiplied by the light transmittance T, and the resultant light emission 19 corresponding to the inside of the light transmission suppressing portion 18 is derived to contribute to the light emission even after entering the light transmission suppressing portion 18. Thus, the component 34 of the light emission exiting the light transmission suppressing portion 18 is amplified. Hence, Expression 4 holds true.

Expression 4

(−)LY(a)·Δx (4-a)

(+)LY(d)·Δx (4-b)

(+)LY(b)·Δx(1−T) (1-d)

(−)LY(c)·Δx(1−T) (4-c)

{LY(d)−LY(a)+LY(b)·(1−T)−LY(c)·(1−T)}·Δx (4-e)

That is, when LY(a)+LY(c) (1−T) is nearly equal to LY(b)×(1−T)+LY(d), the value of the terms enclosed by braces in Expression (4-e) is nearly zero, which indicates a desirable combination. Specifically, the absolute value of the difference between LY(a)+LY(c)×(1−T) and LY(b)×(1−T)+LY(d) may be equal to or smaller, than 0.02 times a value obtained by dividing the light emission quantity within the pixel by Δy.

If the above-described relationship is established not only in the X direction but also in the Y direction, the luminance variation can be reduced not only in the X direction but also in the Y direction. That is, for the light emission profile 13 obtained without the light transmission suppressing portion, any Y coordinate value is denoted as y. Then, the integral value of the changing curve of the light emission profile 13 along a line denoted by Y=y is expressed by the function LX(y) of the Y coordinate. The Y coordinates of both ends of the aperture 8 are denoted as (e) and (h). The Y coordinates of both ends of the light transmission suppressing portion are denoted as (f) and (g). Then, it is assumed that h<g<f<e. In this case, the absolute value of the difference between LX(e)+LX(g)×(1−T) and LX(f)×(1−T)+LX(h) may be equal to or smaller than 0.02 times a value obtained by dividing the light emission quantity within the pixel by Δy.

Furthermore, if the light emission profile 13 is appropriately symmetric with respect to the light emission peak 17, a desirable range may be determined as follows based on calculations similar to those carried out when the light transmission suppressing portion 18 has no light transmittance. For the light emission profile 13, any X coordinate value is denoted as x. Then, the integral value of the changing curve of the light emission profile 13 along a line denoted by X=x is expressed by the function LY(x) of the X coordinate. The X coordinate of center of the aperture 8 is set to zero. The X coordinates of both ends of the aperture 8 are denoted as p and −p. The length of the light transmission suppressing portion 18 in the X direction is denoted as v. The inclination of the function LY(x) at x=p is denoted as LY′(p). The inclination of the function LY(x) at x=v/2 is denoted as LY′(v/2). In this case, the light transmission suppressing portion 18 may meet the relationship between T and v in which |LY′(p)−{1−T}×LY′(v/2)|<light emission quantity within pixel/(Δx)²×0.02. The light transmission suppressing portion 18 with such v and T allows the luminance variation in each pixel 7 to be set to at most 2%, which corresponds to the tolerable limit.

The above-described relationship applies not only to the X direction but also to the Y direction. That is, for the light emission profile 13, any Y coordinate value is denoted as y. Then, the integral value of the changing curve of the light emission profile 13 along a line denoted by Y=y is expressed by the function LX(y) of the Y coordinate. The Y coordinate of the center of the aperture 8 is set to zero. The Y coordinates of both ends of the aperture 8 are denoted as q and −q. The length of the light transmission suppressing portion 18 in the Y direction is denoted as w. The inclination of the function LX(y) at y=q is denoted as LY′(q). The inclination of the function LX(y) at x=w/2 is denoted as LX′(w/2). Moreover, the maximum variation in the light emission profile 13 in the Y direction in all the pixels is denoted as Δy. The light emission quantity within the pixel refers to the total quantity of light emission through the aperture 8 except for a portion shielded by the light transmission suppressing portion 12. In this case, the light transmission suppressing portion 18 may meet the relationship between T and w in which |LX′(q)−{1−T}×LX′(w/2)|<light emission quantity within pixel/(Δy)²×0.02.

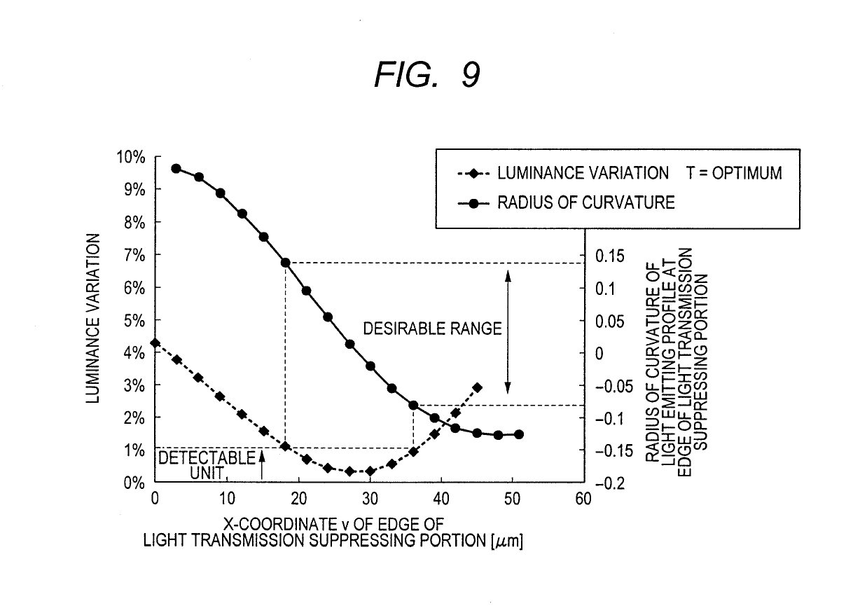

To allow the luminance variation to stably remain smaller than 2% with respect to the variation in the position of the light transmission suppressing portion 18, |LV′(p)−{1−T}×LY′(v₀)| may be kept stable with respect to v₀. That is, when |LY′(p)−{1−T}×LY′(v₀)| is differentiated with respect to v₀, the differentiation results in LY″(v₀)=0 (namely, LY has a radius of curvature of 0). In this case, the resultant value is stable (because the result is an extreme value). Additionally, v₀ denotes the average value, for all the pixels, of the length v of the light transmission suppressing portion 18 in the X direction. The desirable range of the radius of curvature of LY will be described with reference to FIG. 9. In FIG. 9, the axis of abscissa indicates the coordinate v of the end of the light transmission suppressing portion 18, and the left-hand axis of the ordinates indicates the luminance variation obtained with the optimized light transmittance. The right-hand axis of the ordinates indicates the radius of curvature of the light emission profile LY at the coordinate of the end of the light transmission suppressing portion 18 which radius is obtained with the optimized light transmittance. The radius of curvature may be within the range of −0.08 to 0.13 and may be equal to or smaller than the tolerable limit. The light transmittance T may be within the range of 5% to 95%, which meets |LY′(a)−{1−T}×LY′(v₀)|<(light emission within pixel)/(Δx)²×0.01 where v denotes the radius of curvature.

The average value, for all the pixels, of the length v of the light transmission suppressing portion in the X direction is denoted as v₀. The changing curve of the light emission profile normalized so as to exhibit 1 as a maximum value of LY(x) is denoted as LY1(x). Furthermore, the radius of curvature of changing curve of the light emission profile resulting from the integration of the LY1(x) is denoted as LY″1(x). Then, the light transmission suppressing portion may have v₀ such that −0.08<LY″1 (v₀)·(Δx)²<0.13. Then, |LY′(p)−{1−T}×Y′(v₀)|<light emission quantity within pixel/(Δx)²×0.01 may be satisfied. The above-described relationship applies not only to the X direction but also to the Y direction. That is, the average value, for all the pixels, of the length w of the light transmission suppressing portion in the Y direction is denoted as w₀. The changing curve of the light emission profile normalized so as to exhibit 1 as a maximum value of LY(x) is denoted as LX1(y). Furthermore, the radius of curvature of changing curve of the light emission profile resulting from the integration of the LX1(y) is denoted as LX″1(y). Then, the light transmission suppressing portion may have w₀ such that −0.08<LX″1 (w₀)·(Δy)²<0.13. Then, |LX′(q)−{1−T}×LX′(w₀)|<light emission quantity within pixel/(Δy)²×0.01 may be satisfied.

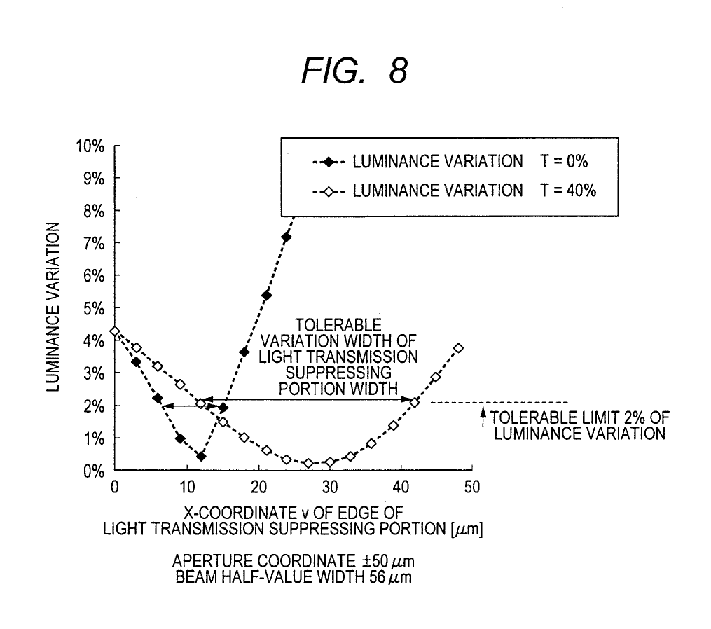

FIG. 8 illustrates an example of a comparison between the tolerable variation widths of the light transmission suppressing portions 12 and 18 according to the second exemplary embodiment and the third exemplary embodiment, respectively. In FIG. 8, the axis of abscissa indicates the coordinate (b) of the end of each of the light transmission suppressing portions 12 and 18. The axis of ordinate indicates the luminance variation, a value obtained by normalizing a luminance difference from the average luminance of each pixel. In FIG. 8, the black filled-in squares correspond to a light transmittance of 0% according to the second exemplary embodiment. The blank squares correspond to a light transmittance of 40% according to the third exemplary embodiment. In this case, b₀ meeting LY″(b₀)=0 is 28 μm. Furthermore, the light emission profile 13 is a normal distribution with a half-width value of 56 μm; the maximum variation 29 in the light emission position is 15 μm. Thus, for the light transmission suppressing portion 18 provided with a light transmittance, selection of the optimum b₀ enables an increase in the tolerable variation width of the light transmission suppressing portion 18 in size.

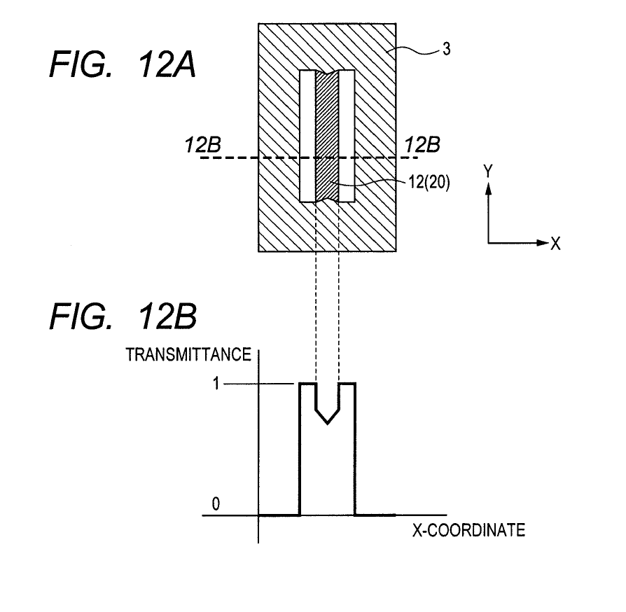

Now, a fourth embodiment will be described. The fourth embodiment is different from the third embodiment in that the light transmittance of a light transmission suppressing portion 20 is distributed. The distribution of the light transmittance may be such that the light transmittance decreases toward the center of the light transmission suppressing portion 20. An example is illustrated in FIGS. 12A and 12B. FIG. 12A is a schematic diagram of the light transmission suppressing portion 20 provided in the pixel 7, as seen from the Z direction, and having a light transmittance. FIG. 12B illustrates the light transmittance observed between d and d′. The present exemplary embodiment enables a further increase in the tolerable width of the light transmission suppressing portion 20.

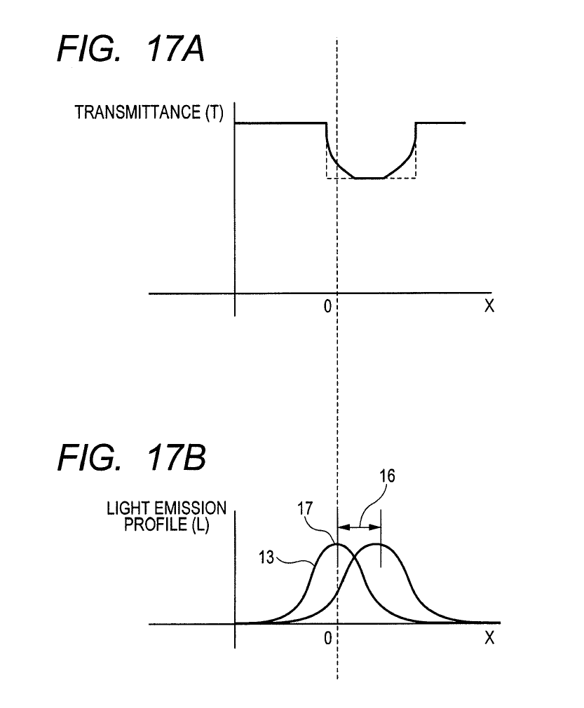

The effects of the light transmission suppressing portion 20 will be described with reference to FIGS. 17A and 17B. FIG. 17A illustrates the light transmittance of peripheries of the light transmission suppressing portion 18 and the light transmission suppressing portion 20 (parts of FIG. 7B and FIG. 12B). In FIG. 17A, a dotted line indicates the light transmittance of the light transmission suppressing portion 18. A solid line indicates the light transmittance of the light transmission suppressing portion 20. FIG. 17B illustrates the light emission profile 13 obtained if the light emission position varies as illustrated at 16. The light emission profile 13 is laterally symmetric with respect to the light emission peak 17. A variation of zero indicates that the central position of the light emission peak 17 coincides with the central position of each of the light transmission suppressing portions 18 and 20.

Table 1 illustrates differences in light emission quantities among combinations of the light transmission suppressing portions 18 and 20 and the light emission position variation 16. The light emission quantity obtained when the light transmission suppressing portion 18 involves a light emission position variation of zero is denoted as (a). In this case, the light emission quantity decreases by (b) if the light emission position variation 16 shifts by Δx. Then, the light emission quantity obtained when the light transmission suppressing portion 20 involves a light emission position variation of zero is denoted as (c). If the light emission position variation 16 shifts by Δx, the light emission peak 17 shifts toward a higher light transmittance. Thus, the change quantity becomes smaller, by +d, than that obtained with a constant light transmittance. Hence, the luminance variation can be made smaller over a wider range when the light transmission suppressing portion has a distributed light transmittance than when the light transmission suppressing portion has a constant light transmittance.

TABLE 1

| | | Light emission quantity |
|---|---|---|
| Light transmission | Light emission | of light transmission |
| suppressing portion | position variation | suppressing portion |
| Constant light | 0 | a |
| transmittance | Δx | a − b |
| Distributed light | 0 | c |
| transmittance | Δx | c − b + d |

According to the present exemplary embodiment, in particular, when LY(a)+LY(c) (1−T) is nearly equal to LY(b)×(1−T)+LY(d), if (inclination for light emitting luminance/light emitting luminance) and (inclination for light transmittance/light transmittance) are equal at the end of the light transmission suppressing portion 20, the luminance variation can be more effectively reduced. This will be specifically described with reference to Expression 5.

$$\begin{matrix}Expression 5 & \\ LY ( c ) \cdot T ( c ) \cdot Δ x + \frac{1}{2} \cdot \{ {LY}^{′} ( c ) T ( c ) + LY ( c ) {T}^{′} ( c ) \} \cdot Δ {x}^{2} & ( 5 a ) \\ LY ( b ) \cdot T ( b ) \cdot Δ x + \frac{1}{2} \cdot \{ {LY}^{′} ( b ) T ( b ) + LY ( b ) {T}^{′} ( b ) \} \cdot Δ {x}^{2} & ( 5 b ) \\ \{ {LY}^{′} ( c ) T ( c ) - {LY}^{′} ( b ) T ( b ) + LY ( c ) {T}^{′} ( c ) - LY ( b ) {T}^{′} ( b ) \} Δ {x}^{2} & ( 5 c ) \\ T ( b ) = T ( c ) , {T}^{′} ( b ) = - {T}^{′} ( c ) , & ( 5 b ) \\ [ \{ {LY}^{′} ( c ) - {LY}^{′} ( b ) \} T ( b ) + \{ LY ( c ) + LY ( b ) \} {T}^{′} ( c ) ] \cdot Δ {x}^{2} & ( 5 e ) \\ \frac{{LY}^{′} ( c ) - {LY}^{′} ( b )}{LY ( c ) + LY ( b )} = \frac{{T}^{′} ( c )}{T ( c )} & ( 5 f ) \\ \frac{{LY}^{′} ( c )}{LY ( c )} = \frac{{T}^{′} ( c )}{T ( c )} & ( 5 g )\end{matrix}$$

With the light transmittance distributed, the light emission profile 13 positioned at the light transmission suppressing portion 20 contributes to the light emission within the pixel as described above. In this case, Expression (2-e) may be transformed into Expression (5-a). The Δx² term is an impact term for the light transmittance distribution. Expression (5-b) relates to the coordinate (b) of the end of the light transmission suppressing portion 20. This corresponds to a component of the light emission within the pixel which is reduced in light emission quantity upon traveling through the aperture 8 if the light emission position variation 16 shifts by Δx. Expression (5-c) indicates the sum of light emissions traveling through the aperture 8 when LY(a)+LY(c) (1−T) is nearly equal to LY(b)×(1−T)+LY(d). The first terms of Expressions (5-a) and (5-b) are removed, with only the difference between the second terms thereof left. For easy interpretation, it is assumed that the absolute value of the light transmittance and the inclination for the light transmittance at one end of the light transmission suppressing portion 20 are equal to those at the other end of the light transmission suppressing portion 20, as indicated by Expression (5-d). Expression (5-e) corresponds to Expression (5-c) with the constraint in Expression (5-d) applied thereto. This in turn corresponds to the Δx² term. That is, an error increases more as variation in Δx increases. That is, a decrease in this term enables a stable reduction in luminance difference if the Δx, that is, the light emission position variation 16, increases. If the Δx can be increased only by a certain amount, the tolerable range meeting the tolerable limit is increased for a variation in the coordinate of end of the light transmission suppressing portion 20. The value of Expression (5-e) is assumed to be zero, and Expression (5-f) is obtained by transformation. Then, the average values of (b) and (c) are adopted for LY and |LY′|. When it is assumed that LY(c)=LY(b) and that LY′(c)−LY′(b), Expression (5-g) is given.

That is, the value of Expression (5-c) decreases if (inclination for light emission intensity/light emission intensity) and (inclination for light transmittance/light transmittance) are nearly equal at the end of the light transmission suppressing portion 20. Furthermore, when the inclination, in an in-plane direction, of the light transmittance distribution increases monotonically in the X direction, the absolute value of the inclination is the largest at the end of the aperture. Thus, the light transmittance distribution within the aperture 8 has an insignificant impact, and the impact of the ends of the aperture 8 may be exclusively taken into account. The phrase “(inclination for light emission intensity/light emission intensity) and (inclination for light transmittance/light transmittance) are nearly equal” as used herein refers to a case where the value of the terms enclosed by the brackets in Expression (5-e) is sufficiently smaller than the Δx, that is, the light emission position variation 16. If a plurality of light emission peaks 17 are present within one pixel, one of the following two measures can be taken: one light transmission suppressing portion 12 is provided which covers all the light emission peaks 17, and a plurality of light transmission suppressing portions 12 are provided for the respective light emission peaks 17, which is better.

The present invention will be described below with reference to specific examples.

### Example 1

In the present example, an electron beam display including the light transmission suppressing portions 12 illustrated in FIGS. 1A and 1B was manufactured. First, a method for producing the face plate 1, which is characteristic of the present invention, will be described.

Step 1: Preprocessing of a Substrate

A substrate of soda lime glass was annealed and cleaned.

Step 2: Formation of Black Members

A black paste forming the black members 3 was applied to a front surface of the substrate to a thickness of 5 μm. A carbon black with a photosensitizing agent mixed therein was used as the black paste. After the application, the substrate was exposed so as to be shaped to have a plurality of apertures 8 per sub-pixel as shown in FIG. 1A. The exposed substrate was then developed to obtain a desired pattern. The pixels were arranged at a pixel pitch 21 of 210 μm in the X direction and at a pixel pitch 11 of 630 μm in the Y direction. First, to acquire a light emission profile 13, the size of the aperture 8 was set to 150 μm in the X direction and to 500 μm in the Y direction. In each electron beam display, 5,760 apertures 8 were arranged in the X direction, and 1,080 apertures 8 were arranged in the Y direction. Thereafter, the substrate was burned at 450°.

Step 3: Formation of Phosphors

Then, RGB phosphors 2 were formed by the screen printing method. The phosphors 2 used were P22 phosphors manufactured by Kasei Optronics Co., Ltd. (since taken over by Mitsubishi Chemical Corporation) and including red: P22RE3 (Y₂O₂S), green: P22GN4 (ZnS:Cu and Al), and blue: P22B2 (ZnS:Ag and Cl). The phosphors 2 were 1 μm in average particle size and were formed to have an average film thickness of 4 μm. Thereafter, the substrate was burned at 450°.

Step 4: Formation of Metal Backs

Then, the metal backs 4 were produced using the filming method, which is well-known in the field of CRTs. A resin intermediate film was formed, and then aluminum was formed to a thickness of 100 nm by the vacuum vapor deposition technique. Thereafter, the substrate was burned at 450° C., and the resin intermediate film was removed.

Step 5: Formation of a Vacuum Container

The face plate 1 was formed through the above-described steps. The face plate 1 was combined with the rear plate 9 to form a vacuum container. The vacuum container, serving as an electron beam display, was checked for operation. Methods for producing the rear plate 9 and the electron-emitting devices 10 will be omitted.

The distance between the electron-emitting device 10 and wiring (not shown in the drawings) was set nearly equal to the left and right in all the directions. Furthermore, the distance between the face plate 1 and the rear plate 9 was set to 2 mm. The main light emission areas 6 of electron beams were as illustrated in FIG. 1A when the produced image display panel was driven at an element driving voltage of 16 V and an acceleration voltage of 10 kV.

### Step 6: Check of the Light Emission Profile and the Luminance Peak Position Deviation Quantity

The electron beam display was driven, and light emission images were picked up using a two-dimensional luminance meter (CA2000 manufactured by Konica Minolta Sensing, Inc.). Thus, an integrated light emission profile 15 and a light emission position variation 16 were acquired. For the light emission profile 13, the average of the light emission profiles obtained at the pixel positions was calculated to be a typical light emission profile. The light emission profile 13 was shaped almost like a normal distribution with a half-value width of 56 μm. Furthermore, in all the light emission profiles, the light emission position variation Δx of the center value in the X direction was up to 15 μm. Hence, 15/56=26%. This corresponds to a light emission variation of at most 30%, which allows the electron beam display to work appropriately in a practical sense.

Step 7: Determination of the Aperture Size

Then, the size of the aperture 8 was determined as follows with prevention of color mixture taken into account: 100 μm in the X direction and 250 μm in the Y direction. A panel with no light transmission suppressing portion 12 but only the apertures 8 arranged therein had a luminance of about 600 cd/m².

Step 8: Determination of the Size of the Light Transmission Suppressing Portion

Since the light emission position variation Δx was 15 μm in the X direction and the aperture 8 was 100 μm in size (50 μm on each side), light transmission suppressing portions 12 were each produced so as to have ends located at ±15 μm or ±20 μm from the center symmetrically with respect to the center of the light transmission suppressing portions 12.

Step 9: Formation of an Electron Beam Display with the Light Transmission Suppressing Portions

An electron beam display according to the present example was produced by carrying out steps 1 to 5, described above, based on the sizes of the aperture 8 and the light transmission suppressing portion 12 determined in steps 7 to 9. That is, the aperture 8 was 100 μm in the X direction and 250 μm in the Y direction as determined in step 7, and the light transmission suppressing portion 12 was sized as determined in step 8. Furthermore, the light transmission suppressing portion 12 was formed of the same material as that of the black member 3 described in step 2.

In the electron beam display illustrated in FIGS. 1A and 1B and manufactured as described above, the luminance variation among the pixels was up to 1.5% for ±15 μm, and up to 4.4% for ±20 μm, in the light transmission suppressing portion 12. The results are shown in Table 2.

Furthermore, when the light transmission suppressing portion 12 was set equal to each of 10%, 18%, and 28% of the aperture 8 in area, luminance unevenness was not observed in any of the cases. Bright screens were obtained in all the cases.

### Comparative Example 1

An electron beam display was produced in the same manner as that in Example 1. However, no light transmission suppressing portion 12 was arranged in the electron beam display. In this case, the luminance variation among the pixels was up to 4.6%. Furthermore, in a form with the light emission peak not covered, light transmission suppressing portions 16 were each arranged so as to have the ends with coordinates of 0 μm and 30 μm from the center of the aperture. In this case, the luminance variation among the pixels was up to 28%. The results are shown in Table 2.

Furthermore, an electron beam display was produced in the same manner as that in Example 1 except that the light transmission suppressing portion 12 was set to each of 5% and 30% of the aperture in area. Then, in any of the cases, luminance unevenness was observed. The electron beam display including the light transmission suppressing portions each with the 30% thereof in area provides darker screens than the electron beam display in Example 1.

TABLE 2

| | Example 1 | Comparative Example 1 | | |
|---|---|---|---|---|
| Coordinates of ends | ±15 | ±20 | 0 | 0.30 |
| of light transmission | | | | |
| suppressing portion | | | | |
| (μm) | | | | |
| Luminance variation | 1.5 | 4.4 | 4.6 | 28.0 |
| (%) | | | | |

### Example 2

Only steps different from those of Example 1 will be described below.

Step 5

The distance between the electron-emitting device 10 and the wiring was changed so as to form an asymmetric beam.

Step 6

Images picked up by the electron beam display produced as described above showed that the light emission profiles were each asymmetric. In the light emission profile, the half-value width in the X direction was 56 μm. The X coordinate of the light emission center with respect to the pixel was −10 μm. The light emission position variation Δx of the center position measured was up to 15 μm in the X direction. Hence, 15/56=26%. This corresponds to a light emission variation of at most 30%, which allows the electron beam display to work appropriately in a practical sense.

Step 7

The aperture 8 was set to 100 μm in size with possible color mixture taken into account. A panel with no light transmission suppressing portion 12 but only the apertures 8 arranged therein had a luminance of about 600 cd/m².

Step 8

Then, the coordinates of the ends of the light transmission suppressing portion 12 were determined so that for the light transmission suppressing portion 12, LY(a)+LY(c) and LY(b)+LY(d) were nearly equal. Since the ends of the aperture are positioned at ±50 μm of the coordinates of ends of the light transmission suppressing portion 12, (a)=50 and (d)=−50. The corresponding LY(a) and LY(d) can be read based on the coordinates to determine the corresponding coordinates of (b) and (c).

Two typical types of light transmission suppressing portions with ((c)=−28.5 and (b)=20) and ((c)=−23.5 and (b)=10), respectively, were produced and evaluated. In this case, the difference between LY(a)+LY(c) and LY(b)+LY(d) was equal to or smaller than 0.06 (cd/m).

Based on the values of the light emission within the pixel and Δx, the desirable range of [LY(a)+LY(c)] and [LY(b)+LY(d)] was equal to or smaller than about 0.0667 (cd/m). Both of the two types exhibited a nearly equal range as shown in Table 2.

Step 9

An electron beam display according to the present example was produced by carrying out steps 1 to 5 based on the sizes of the aperture 8 and the light transmission suppressing portion 12 determined in steps 7 to 9. In the thus produced display, the luminance difference between any pixels was measured. In this case, the luminance variation between any pixels was up to 4.6% and 2.9%.

### Comparative Example 2

In the case of Example 2, when no light transmission suppressing portion 12 was arranged in the display, the luminance variation between any pixels was 6.4%. Furthermore, in another comparative example, an electron beam display including the light transmission suppressing portions 12 with ((c)=−25 and (b)=−15) was produced. In this case, the difference between LY(a)+LY(c) and LY(b)+LY(d) was 0.173 [cd/m]. The luminance variation between any pixels was up to 7.2%.

The results for Example 2 and Comparative Example 2 are shown in Table 3.

TABLE 3

| | | | Comparative | |
|---|---|---|---|---|
| | Example 2 | | Example 2 | |
| Difference between LY(a) + | 0.012 | 0.005 | 0.098 | 0.173 |
| LY(c) and LY(b) + LY(d) | | | | |
| (cd/m) | | | | |
| Coordinate of (c) of light | −28.5 | −23.5 | None | −25 |
| transmission suppressing | | | | |
| portion (μm) | | | | |
| Coordinate of (b) of light | 20 | 10 | None | −15 |
| transmission suppressing | | | | |
| portion (μm) | | | | |

### Example 3

Only steps different from those of Example 1 will be described below.

Step 8

With the coordinate of the center of the aperture set to zero, the coordinates of the ends of the light transmission suppressing portion 12 were set to ±15 μm. In this case, 2,600 (cd/m²) was measured by: the difference between the inclination, in the X direction, of a light emission profile 15 based on integration at the end of the aperture 8 and the inclination, in the X direction, of a light emission profile 15 based on integration at the end of the light transmission suppressing portion 12. This value became about 4,400 (cd/m²) obtained from 0.02×light emission within pixel/(Δx)² in this measurement, which was a sufficiently smaller value. In the thus produced electron beam display, the maximum value of the luminance variation between any pixels was 1.9%.

### Comparative Example 3

An electron beam display was produced by carrying out steps 1 to 5 in Example 1. However, at this time, in step 2, simultaneously with formation of the black members 3, light transmission suppressing portions 18 were formed each of which corresponded to the light transmission suppressing portion 12 including the ends with coordinates of 19 μm and 49 μm from the center of the aperture. In this case, 4,800 (cd/m²) was measured by: the difference between the inclination, in the X direction, of a light emission profile 15 based on integration at the end of the aperture 8 and the inclination, in the X direction, of a light emission profile 15 based on integration at the end of the light transmission suppressing portion 12. The size of the aperture was set to 100 μm in the X direction and 250 μm in the Y direction; these values were determined by the same procedure as that in Example 1. In the thus produced electron beam display, the maximum value of the luminance variation among pixels was 3.8%. Furthermore, in a display produced by a similar production method but including no light transmission suppressing portion 12, the maximum value of the luminance variation among the pixels was 4%.

The results for Example 3 and Comparative Example 3 are shown in Table 4.

TABLE 4

| | |
|---|---|
| | Comparative |
| Example 3 | Example 3 |

| | | | |
|---|---|---|---|
| Coordinate for light | 15 | 19 | 0 |
| transmission suppressing | | | |
| portion (μm) | | | |
| Luminance variation (%) | 1.90 | 3.80 | |
| Difference in inclination | 2600 | 4800 | — |
| between end of aperture and | | | |
| end of light transmission | | | |
| suppressing portion (cd/m²) | | | |

### Example 4

Only steps different from those of Example 2 will be described below. In the present example, as illustrated in FIGS. 7A and 7B, the light transmission suppressing portion 12 was provided with a light transmittance. The light transmission suppressing portion 12 with the light transmittance distribution as illustrated in FIGS. 7A and 7B is denoted by reference numeral 18.

Step 8

In the present example, the light transmission suppressing portion 18 had a light transmittance as illustrated in FIGS. 7A and 7B. The light transmission suppressing portion 18 was arranged such that LY(a)+LY(c) (1−T) was nearly equal to LY(b)+LY(d) (1−T), based on FIGS. 16A to 16C and Expression 4, corresponding to the third embodiment.

When the center of the aperture 8 was set to zero, (a)=50 and (d)=−50. The light transmittance T was set to each of 20% and 40%. A combination of (T=20% and (c)=−28 and (b)=20) and a combination of (T=40% and (c)=−27 and (b)=20) were determined for light emission profiles. The coordinates were in units of μm.

Step 9

The light transmission suppressing portions 18 were produced in a step different from that in which the apertures 8 were formed. The light transmission suppressing portions 18 were deposited by the sputtering method. The light transmittance of each of the light transmission suppressing portions 18 was adjusted based on the thickness thereof. The pattern of the light transmission suppressing portions 18 was formed by a photo process.

Table 5 shows the maximum value of the luminance variation between any pixels in and the luminance value (light emission within pixel) for the electron beam display according to the present invention, together with the corresponding values in Example 2. Table 5 shows that all the luminance variation values are about 5%, which are smaller than 6.4% observed without the light transmission suppressing portion 16. On the other hand, the luminance value was 155 cd/m² in Example 2 but was 224.3 to 298.2 cd/m² in the present example.

TABLE 5

| | Example 2 | Example 4 | |
|---|---|---|---|
| Difference between LY(a) + LY(c) (1 − | 0.012 | 0.029 | 0.063 |
| T) and LY(b) (1 − T) + LY(d) (cd/m) | | | |
| Coordinate of (c) of light | −28.5 | −28 | −27 |
| transmission suppressing portion | | | |
| Coordinate of (b) of light | 20 | 20 | 20 |
| transmission suppressing portion | | | |
| Light transmittance of light | 0 | 20 | 40 |
| transmission suppressing portion (%) | | | |
| Luminance variation (%) | 4.6 | 5.5 | 5.1 |
| Luminance absolute value (cd/m²) | 155.0 | 224.3 | 298.2 |

### Example 5

Only steps different from those of Example 4 will be described below.

Step 8

The integrated light emission profile 15 indicated that when the average coordinates v₀ of the left and right ends of the light transmission suppressing portion 18 were −30 μm and 30 μm, respectively, the radius of curvature LY″(v₀) was zero. Furthermore, LY′(v₀) was 0.022. Additionally, LY′(a) was 0.013 as is the case with Example 1. Since |LY′(a)−{1−T} LY′(b)|=0 is optimum, the light transmittance T of the light transmission suppressing portion 18 was set equal to 1−LY′(a)/LY′(b)=41%.

In the thus produced electron beam display, the in-plane luminance variation was 0.31%. Furthermore, the tolerance of the X coordinate of the end of the light transmission suppressing portion 18 (that is, the coordinate of (b)) was ±13 μm when the in-plane luminance variation was equal to or smaller than 2%. In Example 1, the tolerance of the X coordinate of the end of the light transmission suppressing portion 18 (that is, the coordinate of (b)) was ±4 μm when the in-plane luminance variation was equal to or smaller than 2%. Thus, the present example served to increase the tolerance of the X coordinate of end of the light transmission suppressing portion 18.

### Example 6

Only steps different from those of Example 4 will be described below. In the present example, as illustrated in FIGS. 12A and 12B, the light transmission suppressing portion 12 was provided with a light transmittance distribution. The light transmission suppressing portion 12 with the light transmittance distribution as illustrated in FIGS. 12A and 12B is denoted by reference numeral 20.

Step 8

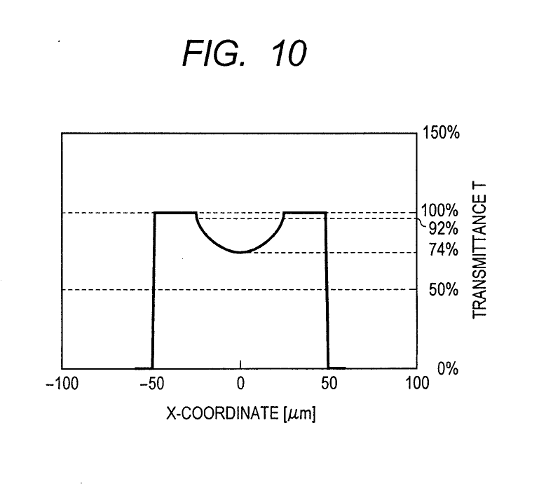

The light transmission suppressing portions 20 were produced as follows. The coordinates of the ends of the light transmission suppressing portion 20 were selected so that LY(a)+LY(c) (1−T) was nearly equal to LY(b)+LY(d) (1−T), and the minimum light transmittance was set to 74%. At this time, the coordinates of (c) and (b) were −24 μm and 24 μm, respectively. In this case, (inclination for light emission intensity/light emission intensity) and (inclination for light transmittance/light transmittance) were set nearly equal at the coordinate of the end of the light transmission suppressing portion 20. Furthermore, the corresponding light transmittance distribution was shaped like a quadratic curve the center of which corresponds to the minimum light transmittance. The light transmission suppressing portion 20 was set to exhibit a light transmittance of 92% at each end thereof. The light transmission suppressing portion 20 was also set to exhibit a light transmittance of 74% at the center thereof. FIG. 10 illustrates the light transmittance distribution in the X direction.

Step 9

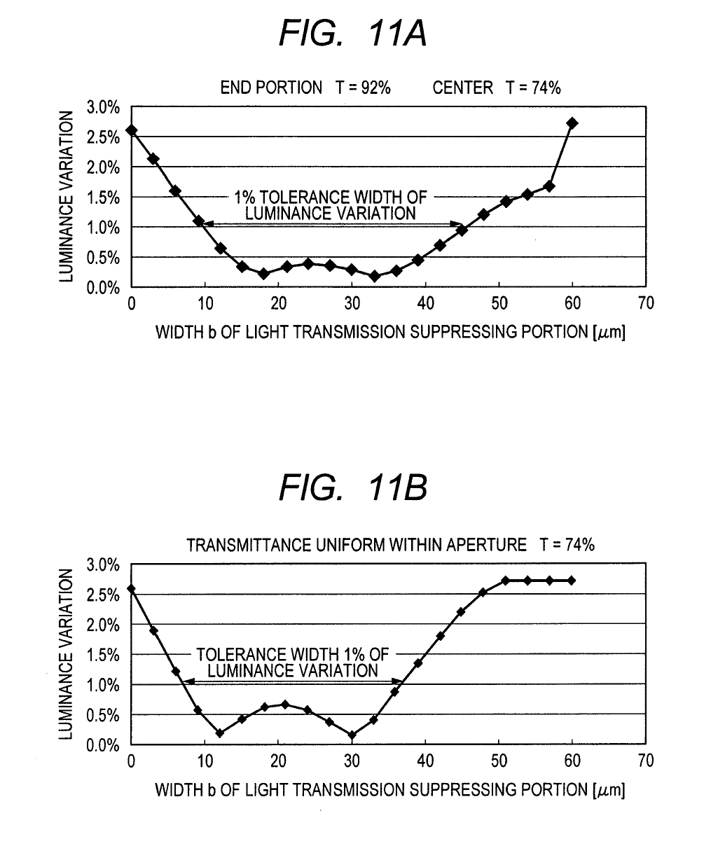

Only the step of forming the light transmission suppressing portions 20 was carried out separately from the step of forming the apertures. The light transmission suppressing portions 20 was deposited by the ink jet method. The light transmittance distribution of each of the light transmission suppressing portions 20 was adjusted based on the thickness thereof. The size of the light transmission suppressing portion 20 was defined by a photo process. In the thus finished electron beam display, the tolerable variation width of the light transmission suppressing portion 20 was 35 μm when the luminance variation was smaller than 1%, as illustrated in FIG. 11A.

### Comparative Example 6

An electron beam display was produced in the same manner as that in Example 6. The light transmission suppressing portions 20 were uniformly produced so as to have a fixed light transmittance of 74%. In the thus finished electron beam display, the tolerable variation width of the light transmission suppressing portion 20 was 29 μm when the luminance variation was smaller than 1%, as illustrated in FIG. 11B.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-233368, filed Oct. 18, 2010, which is hereby incorporated by reference herein in its entirety.

What is claimed is:

1. An electron beam display comprising:
a face plate including a plurality of pixels having a phosphor emitting light responsive to irradiation with an electron, and a light transmitting aperture arranged correspondingly to each of the pixels for extracting light emitted from the phosphor; and
a rear plate including a plurality of electron-emitting devices each arranged correspondingly to each of the plurality of pixels so as to irradiate electrons to the corresponding pixel, and so that an irradiation current density on an electron beam irradiation surface has an intensity distribution within the corresponding pixel, wherein
a light transmission suppressing portion covers a position of the aperture corresponding to a position at which the irradiation current density of the electron beam is maximum and has an area of 10-28% of an area of the aperture on the electron beam irradiation surface.

2. The electron beam display according to claim 1, wherein
the plurality of electron-emitting devices are classified into a plurality of groups according to arrangement positions of the electron-emitting devices on the rear plate, such that, one group by one group of the electron-emitting devices, the position of the corresponding pixel at which the irradiation current density of the electron beam is maximum is determined.

3. The electron beam display according to claim 1, wherein
the light transmission suppressing portion has a light transmittance equal to or smaller than 5%,
when X, Y coordinates are set in a plane of the face plate,
X is an arbitrary X coordinate value, a function LY(x) of the X coordinate value is derived by integrating a changing curve of the light emitting profile along a line at X=x under a condition without the light transmission suppressing portion, a and d are X coordinate values at both ends of the aperture, and b and c are X coordinate values at both ends of the light transmission suppressing portion,
d<c<b<a is met, and

|(LY(a)+(LY(c))−(LY(b)+(LY(d))|<0.02·(Ip)/ΔAX
is met, wherein the ΔX is a maximum variation of the light emission profile of total pixels in X direction, and Ip is a light emitting quantity within the pixel derived from a total light emission quantity through the aperture except for a portion shielded by the light transmission suppressing portion.

4. The electron beam display according to claim 1, wherein
the light transmission suppressing portion has a light transmittance equal to or smaller than 5%,
when X, Y coordinates are set in a plane of the face plate,
y is an arbitrary Y coordinate value, a function LX(y) of the Y coordinate value is derived by integrating a changing curve of the light emitting profile along a line at Y=y under a condition without the light transmission suppressing portion, e and h are Y coordinate values at both ends of the aperture, and f and g are Y coordinate values at both ends of the light transmission suppressing portion,
h<g<f<e is met, and

|(LX(e)+(LX(f))−(LX(g)+(LX(h))|<0.02·(Ip)/Δy
is met, wherein the Δy is a maximum variation of the light emission profile of total pixels in Y direction, and Ip is a light emitting quantity within the pixel derived from a total light emission quantity through the aperture except for a portion shielded by the light transmission suppressing portion.

5. The electron beam display according to claim 1, wherein
the light transmission suppressing portion has a light transmittance equal to or smaller than 5%,
when X, Y coordinates are set in a plane of the face plate,
X is an arbitrary X coordinate value, a function LY(x) of the X coordinate value is derived by integrating a changing curve of the light emitting profile along a line at X=x under a condition without the light transmission suppressing portion, ±a are X coordinate values at both ends of the aperture, and ±b are X coordinate values at both ends of the light transmission suppressing portion,
−a<−b<b<a is met, and
when an inclinations of the function LY(x) at X=a and X=b are respectively LY′(a) and LY′(b,),

|(LY′(b)−(LY′(a)|<0.02·(Ip)/(ΔX)²
is met, wherein the Δx is a maximum variation of the light emission profile of total pixels in X direction, and Ip is a light emitting quantity within the pixel derived from a total light emission quantity through the aperture except for a portion shielded by the light transmission suppressing portion.

6. The electron beam display according to claim 1, wherein
the light transmission suppressing portion has a light transmittance equal to or smaller than 5%,
when X, Y coordinates are set in a plane of the face plate,
y is an arbitrary Y coordinate value, a function LX(y) of the Y coordinate value is derived by integrating a changing curve of the light emitting profile along a line at Y=y under a condition without the light transmission suppressing portion, ±e are Y coordinate values at both ends of the aperture, and ±f are Y coordinate values at both ends of the light transmission suppressing portion,
−e<−f<f<e is met, and
when an inclinations of the function LX(y) at y=e and y=f are respectively LX′(e) and LX′(f),

|(LX′(f)−(LX′(e)|<0.02·(Ip)/(Δy)²
is met, wherein the Δy is a maximum variation of the light emission profile of total pixels in Y direction, and Ip is a light emitting quantity within the pixel derived from a total light emission quantity through the aperture except for a portion shielded by the light transmission suppressing portion.

7. The electron beam display according to claim 1, wherein
the light transmission suppressing portion has a light transmittance T,
when X, Y coordinates are set in a plane of the face plate,
X is an arbitrary X coordinate value, a function LY(x) of the X coordinate value is derived by integrating a changing curve of the light emitting profile along a line at X=x under a condition without the light transmission suppressing portion, a and d are X coordinate values at both ends of the aperture, and b and c are X coordinate values at both ends of the light transmission suppressing portion,
d<c<b<a is met, and

|(LY(a)+(LY(c)·(1−T))−(LY(b)·(1−T)+(LY(d))|<0.02·(Ip)/ΔX
is met, wherein the ΔX is a maximum variation of the light emission profile of total pixels in X direction, and Ip is a light emitting quantity within the pixel derived from a total light emission quantity through the aperture except for a portion shielded by the light transmission suppressing portion.

8. The electron beam display according to claim 1, wherein
the light transmission suppressing portion has a light transmittance T, which is larger than 5%,
when X, Y coordinates are set in a plane of the face plate,
y is an arbitrary Y coordinate value, a function LX(y) of the Y coordinate value is derived by integrating a changing curve of the light emitting profile along a line at Y=y under a condition without the light transmission suppressing portion, e and h are Y coordinate values at both ends of the aperture, and f and g are Y coordinate values at both ends of the light transmission suppressing portion,
h<g<f<e is met, and

|(LX(e)+(LX(g)·(1−T))−(LX(f)·(1−T)+(LX(h))|<0.02·(Ip)/Δy is met,
wherein the Δy is a maximum variation of the light emission profile of total pixels in Y direction, and Ip is a light emitting quantity within the pixel derived from a total light emission quantity through the aperture except for a portion shielded by the light transmission suppressing portion.

9. The electron beam display according to claim 1, wherein
the light transmission suppressing portion has a light transmittance T,
when X, Y coordinates are set in a plane of the face plate,
X is an arbitrary X coordinate value, a function LY(x) of the X coordinate value is derived by integrating a changing curve of the light emitting profile along a line at X=x under a condition without the light transmission suppressing portion,
a X coordinate of a center of the aperture is 0, p and −p are X coordinate values at both ends of the aperture, and v is a length of the light transmission suppressing portion in X direction, LY′(p) is an inclination of the function LY(x) at x=p, LY′(v/2) is an inclination of the function LY(x) at x=v/2,
T and v meet a relation:

|(LY′(p)−(1−T)*(LY′(v/2)|<(Ip)/(ΔX)²*0.02
is met, wherein
the ΔX is a maximum variation of the light emission profile of total pixels in X direction, and Ip is a light emitting quantity within the pixel derived from a total light emission quantity through the aperture except for a portion shielded by the light transmission suppressing portion.

10. The electron beam display according to claim 1, wherein
the light transmission suppressing portion has a light transmittance T,
when X, Y coordinates are set in a plane of the face plate,
y is an arbitrary Y coordinate value, a function LX(y) of the Y coordinate value is derived by integrating a changing curve of the light emitting profile along a line at Y=y under a condition without the light transmission suppressing portion,
a Y coordinate of a center of the aperture is 0, q and −q are X coordinate values at both ends of the aperture, and w is a length of the light transmission suppressing portion in Y direction, LX′(w) is an inclination of the function LX(y) at y=q, LX′(w/2) is an inclination of the function LX(y) at x=w/2,
T and w meet a relation:

|(LX′(q)−(1−T)*(LX′(w/2)|<(Ip)/(ΔX)²*0.02
is met, wherein
the Δy is a maximum variation of the light emission profile of total pixels in Y direction, and Ip is a light emitting quantity within the pixel derived from a total light emission quantity through the aperture except for a portion shielded by the light transmission suppressing portion.

11. The electron beam display according to claim 9, wherein,
when V₀ is an average value among lengths in X direction of the light transmission suppressing portions in all pixels, LY1(x) is the changing curve of light emission profile normalized such that a maximum value of LY(x) is 1, and LY″1(x) is a radius of curvature of the changing curve of light emission profile derived by integrating LY1(x),
the light transmission suppressing portions have V₀ meeting a relation:
−0.08<LY″1(v₀)·(Δx)²<0.13; and
LY′(p)−{1−T}×LY′(v₀)|<(Ip)/(Δx²)×0.01
is met.

12. The electron beam display according to claim 10, wherein,
when w₀ is an average value among lengths w in Y direction of the light transmission suppressing portions in all pixels, LX1(y) is the changing curve of light emission profile normalized such that a maximum value of LX(y) is 1, and LX″1(y) is a radius of curvature of the changing curve of light emission profile derived by integrating LX1(y),
the light transmission suppressing portions have w₀ meeting a relation:
−0.08<LX″1(w₀)·(Δy)²<0.13; and

|LX′(p)−{1−T}×LX′(w₀)|<(Ip)/(Δy²)×0.01
is met.

13. The electron beam display according to claim 1, wherein,
the light transmission suppressing portion has the light transmittance of a distribution such that the light transmittance is maximum at an end of the light transmission suppressing portion, and changes in a linear inclination tendency from an inner edge of the aperture toward the end of the light transmission suppressing portion.
